(19) United States
(12) Patent Application Publication
(10) Pub. No.: US 2006/0062137 A1
(43) Pub. Date: Mar. 23, 2006

(54) Method and apparatus for securely recording and storing data for later retrieval

(76) Inventor: Arie Ross, Surrey (CA)

Correspondence Address: JEAN M. MACHELEDT, 501 SKYSAIL LANE, SUITE B100, FORT COLLINS, CO, 80525-3133, US

(21) Appl. No.: 11/222,443

(22) Filed: Sep. 8, 2005

Related U.S. Application Data
(60) Provisional application No. 60/607,925, filed on Sep. 8, 2004.

(51) Int. Cl. G11B 7/24; G11B 5/09

(52) U.S. Cl. 369/275.1; 369/47.28; 369/47.1

(57) ABSTRACT

The present invention is a method and apparatus for securely storing data on a compact disk-like device that can interface with existing compact disk players, digital video disk players and disk drives commonly found on personal computers. The apparatus comprises a compact disk plastic substrate having a microprocessor, a system memory, a data memory and a power source embedded thereon. An optical interface device is embedded on the bottom of the substrate and is electrically connected to the microprocessor. The optical interface device comprises an imaging sensor for receiving data from the laser mechanism of a compact disk drive mechanism to store on the present invention, and a micro mirror array for emulating the pits and lands on a standard compact disk that can be read by the laser mechanism as the data retrieved from the present invention. The method of the present invention consists of both storing data received at the optical interface device in the data memory and transmitting data retrieved from the data memory from the optical interface device. The use of a microprocessor in the transfer of data to and from the data memory enables use of data encryption techniques to encrypt the data stored in the data memory and decrypt date retrieved from the data memory. In addition, passwords may be associated with the data stored in the data memory to further prevent unauthorized access to, or copying of, data stored in the data memory.

### FIELD OF THE INVENTION

This application claims priority to pending U.S. provisional patent application No. 60/607,925 filed 08 Sep. 2004.

The present invention relates to a method and apparatus for securely recording and storing electronic data for later retrieval. Specifically, the present invention is concerned with a compact disk having a microprocessor, a memory and an optical interface device embedded thereon for securely recording and storing electronic data.

### BACKGROUND OF THE INVENTION

The compact disk (“CD”) has been used as a media form for data storage for nearly two decades. It is has evolved into a standard medium for storing information such as pre-recorded music and computer programs or applications. It has the advantage of being able to store large amounts of data and its low cost to produce. A recordable version of the CD has also evolved allowing users to record data onto CDs for a number of applications such as data archiving and recording music onto CDs to name a few. The form factor used for the CD (120 mm diameter polycarbonate disks) is also used to store digital video and now the digital video disk (“DVD”) has surpassed the videocassette as the defacto standard format for consumer video entertainment.

CD and DVD manufacturers and the music, television and movie industries are primarily information-based businesses, but its management of its digital data is historically split when it comes to privacy and safeguarding an artist's work. The largest problem these manufacturers and these industries face is their inability to change and evolve a better product that will help safeguard its digital assets for now and in the future.

As a result of the computer technology allowing users to record their own CDs and DVDs, unauthorized copying and software piracy has also emerged becoming a significant problem for software manufacturers and the entertainment industries.

It is, therefore, desirable to have a method and apparatus for securely recording and storing electronic data on a compact disk medium capable of being used with existing compact and digital video disk players and computer compact disk drives which prevents to unauthorized copying of data stored on CDs and DVDs.

### SUMMARY OF THE INVENTION

The present invention is concerned with a method and apparatus for securely recording and storing electronic data for later retrieval, the apparatus adapted to operate with existing compact disk peripheral devices such as CD, DVD, Blu Ray™ and high definition DVD (“HD-DVD”) players and computer compact disk drives of all kinds.

It is an object of the present invention to safeguard information stored on a compact disk.

It is another object of the present invention to provide a digital asset management system designed for maximum data storage and retrieval that is secure.

It is another object of the present invention to provide a compact disk having a microprocessor, a memory and optical interface device embedded thereon that requires a user personal information number (“PIN”) or “password” to access data stored on the compact disk.

It is yet another object of the present invention to provide a compact disk containing a locking or unlocking key to secure and access data stored thereupon and to access other digital asset management support tools.

It is yet another object of the present invention to provide a compact disk that is a digital asset management device which fully protects the digital data stored thereupon.

It is yet another object of the present invention to reduce the risk of unauthorized copying and file sharing of electronic data stored on a compact disk.

It is yet another object of the present invention to store digital data onto a compact disk and to protect said data from unauthorized copying and file sharing.

The present invention is concerned with a method and apparatus for securely storing and retrieving data on a compact disk for use with compact disk peripheral devices as well known by those skilled in the art. For the purposes of this specification, compact disk peripheral devices include, but are not limited to, read-only compact disk drive devices (“CD-ROMs” or “DVD-ROMs”—as used in music or video compact disk playback devices and personal computers) and read-write compact disk peripheral devices or drives (“CD-R/W”, “DVD-R/W” or “CD/DVD burners”) as used in personal computers and the like.

The apparatus comprises of a polycarbonate compact disk substrate, the round plastic form that compact disks are standardized upon, having a microprocessor embedded therein. Operatively attached to the microprocessor, and embedded upon the bottom of the substrate, is an optical interface device adapted to transmit data to, and received data from, a compact disk peripheral device. The optical interface device performs two functions. The first function is to read information transmitted to it by the laser mechanism of a compact disk peripheral device when data is to be stored on the present invention. The second function is to transmit information to the laser pickup mechanism of the compact disk peripheral device when data is to be retrieved from the present invention. Accordingly, the optical interface device is comprised of two sub-components.

The first sub-component is a CMOS monochromatic imaging sensor array that is adapted to receive the incoming modulated light from the laser (whose wavelength is in the range of 400 to 1100 nm) of the compact disk peripheral device as data when the data is to be stored on the apparatus of the present invention. In a representative embodiment of the present invention, two monochromatic sensor arrays are used, each having a grid of pixels, typically 840 pixels wide and 600 pixels high. In addition to reading data from the peripheral device, the sensors determine the position of the laser mechanism in relation to the present invention as it is rotating in the peripheral device.

The second sub-component is micro electro-mechanical system (“MEMS”) micro mirror array that is used to emulate the “pits” and “lands” on a CD when data is to be retrieved from the apparatus of the present invention. In a representative embodiment of the present invention, the micro mirror array is positioned between the two CMOS monochromatic imaging sensor arrays in a linear fashion and consists of a grid of micro mirror elements, each individually controllable. The grid is 1200 mirror elements wide by 840 mirror elements high or 1,008,000 mirror elements in total. The individual mirror elements move to appear as a pit or a land by the laser pickup mechanism as the disk spins in the peripheral device thereby allowing the data to read from the present invention. In a representative embodiment of the present invention, the microprocessor and the optical interface device sub-components are integrated together on a monolithic complementary metal-oxide semiconductor (“CMOS”) device. It should be obvious to those skilled in the art that these elements can be assembled as an application specific integrated circuit (“ASIC”) device.

Operatively connected to the microprocessor is a system memory that also may be resident on the monolithic ASIC device. The system memory is adapted to be programmed with a system program code segment that controls the operations of the microprocessor, the optical interface device, the system memory and a data memory that is operatively connected to the microprocessor to receive and store data. In a representative embodiment of the present invention, the data memory has a capacity of 31 gigabytes but it is envisioned that the capacity can be adapted to store data in excess of 1 terabyte.

The system program code segment comprises a first set of instructions that causes the microprocessor, through data received by the imaging sensors of the optical interface device, to identify the type of compact disk peripheral device the present invention is inserted in. Any data to be stored on the present invention is saved in the data memory. If the data to be stored is to be encrypted, the data is encrypted by the microprocessor prior to being stored in the data memory. Any password or PIN associated with the data being stored is saved as well.

The system program code segment also comprises a second set of instructions that causes the microprocessor to retrieve data stored in the data memory and transmit that data to the micro mirror array of the optical interface device to be read by the laser pickup mechanism of the compact disk peripheral device. If the retrieved data is password-protected, the correct password or PIN must be received before the data is retrieved. If the stored data is encrypted, the microprocessor will decrypt the data prior to transmitting it to the micro mirror array.

In one embodiment of the present invention, a power cell or battery is operatively attached to the apparatus of the present invention to provide electrical power to the microprocessor, the optical interface device, the system memory and the data memory. In a representative embodiment of the present invention, the power required by the embedded electronic devices is generated by static electricity generated by the present invention itself as it spins within a compact disk peripheral device. In this embodiment, the compact disk substrate comprises of an inner disk portion (similar in size to a “mini-disk”) and an outer annular disk portion that can freely spin circumferentially about the inner disk portion, the outer disk maintaining the 120 mm overall diameter of a standard CD. The inner disk portion is comprised of an upper and lower layer that form a V-shaped groove about its circumferential edge when laminated together. The inner edge of the outer disk portion is similarly V-shaped and corresponds to the grooved edge of the inner disk. When the outer disk is sandwiched between the layers that make up the inner disk, a gap is formed between the disks that allow the outer disk to spin freely around the inner disk. Preferably, the gap is in the order of 0.1±0.01 mm. When inserted in a compact disk peripheral device, the outer disk will spin approximately one-half the rotational speed of the inner disk due to frictional forces between the inner and outer disks. As the inner and outer disks are made of polycarbonate, an insulating material, a voltage potential is generated due to the static electricity generated as the disks rub against each other as they are spinning. The positive and negative charges that develop on the contacting edges of the inner and outer disks are collected and then used to power the embedded electronic devices.

The method of the present invention consists of separate methods for storing data onto the apparatus of the present invention and for retrieving data from the apparatus of the present invention. Storing data onto the apparatus comprises receiving data at the imaging sensors of the optical interface device, such as from the laser of a compact disk peripheral device, and then storing the received data in the data memory of the apparatus.

Retrieving data from the apparatus comprises retrieving stored data from the data memory and transmitting the data to the micro mirror array where the mirror elements present the data as pits and lands that can be detected by the laser pickup mechanism of a compact disk peripheral device.

The use of the microprocessor for controlling the storing and retrieving of data from the data memory allows the use of encryption algorithms to optionally encrypt data that is stored in the data memory and decrypting said data upon later retrieval. This adds a layer of security for the data stored in the data memory. Furthermore, the microprocessor may be used to prevent the data from unauthorized copying of file sharing by only allowing access to the data by a user who uses the correct personal information number (“PIN”) to access the data. Further security measures can be incorporated which may include blocking a user if an incorrect PIN is presented to the apparatus a predetermined number of times. If this occurs, a second unblocking PIN must be presented in order to unlock the stored data. Further still, the microprocessor may be programmed to permanently block access to the data if an incorrect unblocking PIN is presented a predetermined number of times.

Broadly stated, one aspect of the present invention is a compact disk for securely receiving and storing data for later retrieval, comprising: a compact disk substrate adapted for insertion into a compact disk peripheral device; a microprocessor operatively connected to said substrate, said microprocessor adapted to control the exchange of data between said compact disk and said compact disk peripheral device; an optical interface device operatively connected to said substrate and to said microprocessor, said optical interface device adapted to receive data from and to transmit data to said compact disk peripheral device; a system memory operatively connected to said microprocessor, said system memory adapted to be programmed with a system program code segment having a first set of instructions adapted to cause said microprocessor to store data received by said optical interface device in said data memory, and having a second set of instructions adapted to cause said microprocessor to retrieve data stored in said data memory for transmittal by said optical interface device, said microprocessor adapted to follow said first set or said second set of instructions when said compact disk in inserted into said compact disk peripheral device; a data memory operatively connected to said microprocessor, said data memory adapted to receive data to be stored for later retrieval; and power means for providing electrical power to said microprocessor, said optical interface device, said system memory and said data memory, said power means operatively attached to said compact disk substrate.

Broadly stated, another aspect of the present invention is a method for storing data on a compact disk for recording and storing data for later retrieval, the method comprising the steps of: providing a compact disk for securely recording and storing data for later retrieval, comprising: a compact disk substrate adapted for insertion into a compact disk peripheral device, a microprocessor operatively connected to said substrate, said microprocessor adapted to control the exchange of data between said compact disk and said compact disk peripheral device, an optical interface device operatively connected to said substrate and to said microprocessor, said optical interface device adapted to receive data from and to transmit data to said compact disk peripheral device, a system memory operatively connected to said microprocessor, said system memory adapted to be programmed with a system program code segment having a first set of instructions adapted to cause said microprocessor to store data received by said optical interface device in said data memory, and having a second set of instructions adapted to cause said microprocessor to retrieve data stored in said data memory for transmittal by said optical interface device, said microprocessor adapted to follow said first set or said second set of instructions when said compact disk in inserted into said compact disk peripheral device, a data memory operatively connected to said microprocessor, said data memory adapted to receive data to be stored for later retrieval, and power means for providing electrical power to said microprocessor, said optical interface device, said system memory and said data memory, said power means operatively attached to said compact disk substrate; receiving data at said optical interface device; and storing said received data in said data memory.

Broadly stated, another aspect of the present invention is a method for retrieving data from a compact disk for recording and storing data for later retrieval, the method comprising the steps of: providing a compact disk having data securely recorded and stored for later retrieval, comprising: a compact disk substrate adapted for insertion into a compact disk peripheral device, a microprocessor operatively connected to said substrate, said microprocessor adapted to control the exchange of data between said compact disk and said compact disk peripheral device, an optical interface device operatively connected to said substrate and to said microprocessor, said optical interface device adapted to receive data from and to transmit data to said compact disk peripheral device, a system memory operatively connected to said microprocessor, said system memory adapted to be programmed with a system program code segment having a first set of instructions adapted to cause said microprocessor to store data received by said optical interface device in said data memory, and having a second set of instructions adapted to cause said microprocessor to retrieve data stored in said data memory for transmittal by said optical interface device, said microprocessor adapted to follow said first set or said second set of instructions when said compact disk in inserted into said compact disk peripheral device, a data memory operatively connected to said microprocessor, said data memory adapted to receive data to be stored for later retrieval, and power means for providing electrical power to said microprocessor, said optical interface device, said system memory and said data memory, said power means operatively attached to said compact disk substrate; retrieving said stored data from said data memory; and transmitting said retrieved data from said optical interface device.

### BRIEF DESCRIPTION OF THE DRAWINGS

FIG. 1 is a top plan view of the apparatus of a first embodiment of the present invention.

FIG. 2 is a bottom plan view of the apparatus of a first embodiment of the present invention.

FIG. 3 is a block schematic diagram of the microprocessor of the apparatus of the present invention.

FIG. 4 is a block schematic diagram of the optical interface device of the apparatus of the present invention.

FIG. 5 is a top plan view of the apparatus of a second embodiment of the present invention.

FIG. 6 is a bottom plan view of the apparatus of a second embodiment of the present invention.

FIG. 7a is a side cross-sectional view of the apparatus of a second embodiment of the present invention along section lines A-A shown in FIG. 5.

FIG. 7b is a side cross-sectional exploded view of the apparatus of a second embodiment of the present invention along section lines A-A shown in FIG. 5.

FIG. 8a is a side cross-sectional view of the apparatus of a second embodiment of the present invention.

FIG. 8b is a close-up side cross-sectional view of section B of the apparatus of a second embodiment of the present invention.

FIG. 9 is a side cross-sectional view of the spin gap of a second embodiment of the present invention.

FIG. 10 is a top plan view of the apparatus of a second embodiment of the present invention illustrating the generation of static electricity.

FIG. 11 is a schematic diagram of the apparatus a second embodiment of the present invention as it generates static electricity.

FIG. 12 is a flow chart diagram illustrating the method of storing data on the apparatus of the present invention.

FIG. 13 is a flow chart diagram illustrating the method of retrieving data from the apparatus of the present invention.

FIG. 14 is a block diagram of the file organizational structure used in the method of the present invention.

### DETAILED DESCRIPTION OF THE PREFERRED EMBODIMENT

The present invention is concerned with a method and apparatus for securely recording and storing data on a compact disk-compatible device for later retrieval.

The apparatus of the present invention digitalizes and transfers digital data, locked in a CD/DVD ROM-like product, directly to or from the source, all the while protecting its data and locking it if and when that data gets moved.

The present invention may be implemented in a number of embodiments. Each embodiment offers different protection and security tools to ensure that data stored on the embedded processor of the present invention is not pirated.

The data stored on the apparatus of the present invention may be played in standard CD/DVD playing devices which includes but are not limited to personal computers, gaming machines, media players, etc. all the while making it difficult, if not impossible, for the data stored on the apparatus to be copied without a valid PIN code.

The apparatus of the present invention is an industry standard 120 mm diameter plastic disk comprising an embedded microprocessor, a two-part monochromatic imaging sensor and a micro mirror array. This microprocessor provides the intelligence of the apparatus.

The apparatus may be implemented in two broad varieties:
1. MultiMedia_Consumer_Version_Device: a full System-On-Chip with a Real-Time Operating System and hi-density storage space for data, and an unsurpassed level of built-in security; it embodies a processor controlled by a computer media player on a computer operating system, with the ability to send and process data onboard the apparatus, as well as carry small programs capable of local execution; and
2. Industry Specific_Version_MultiMedia_Device: in addition to full System-On-Chip, which is an Application Specific Integrated Circuit (ASIC), this version of the apparatus may also be equipped with a Real-Time OS as well as its hi-density storage space for data. The apparatus embodies a processor controlled by a computer media player on a computer operating system, and in the event the apparatus is inserted in a non-CD ROM device the apparatus will have the ability to send binary data to the optical pickup of the device that it is being played in.

Furthermore, either version of the apparatus has the ability to process data on the embedded processor, as well as carry small programs capable of local execution.

The main storage area in the microprocessor is a hi-density flash memory module which, subject to defined security constraints, can have its content updated, and which retains current content when the apparatus is removed from a compact disk playing device or when PIN codes for playing are not recognized by the user's media player.

The apparatus of the present invention may also have math co-processors integrated into the microprocessor chip, thus enabling it to perform quite complex encryption routines relatively quickly. Furthermore, a bio-sensor may also be adopted within the microprocessor to perform Real-Time Lab-On-Disk functions.

The present invention is, therefore, characterized by a microprocessor encompassing a micro mirror array, and a pair of monochromatic imaging sensors positioned on either side of the micro mirror array, the sensors sensitive to monochromatic light having wavelengths ranging from 400 to 1100 nanometers.

Furthermore, the microprocessor has the ability to store additional data (currently up to 31 Gb) on the chip over and above what is held by the traditional standard compact disk (780 Mb), all within an extremely secure environment. These security features built into the apparatus of the present invention provide a level of sophistication not currently available in the commercial world. Data residing in the apparatus can, therefore, be protected against external inspection or alteration.

The use of encryption on the data stored on the apparatus further supplements the physical security of the apparatus, thereby providing an additional layer of protection for the stored data in the event that physical security features of the apparatus are penetrated.

The apparatus of the present invention is designed to be more reliable than a traditional compact disk not equipped with an application specific integrated circuit. The preferred embodiment of the present invention can, currently, store forty times more information than a traditional compact disk, and still be played in traditional places where traditional compact disks are currently being played.

The apparatus of the present invention is also more difficult to tamper with or copy than a traditional compact disk. The apparatus can be disposable or reusable, and can perform multiple functions in a wide range of industries, and is compatible with a variety of portable electronic devices such as portable stereos, personal digital audio devices (compact disk walkmans), and personal computers.

The preferred embodiments of the apparatus of the present invention are focused on five types of compact disks. They include:
1. The apparatus of the present invention acting as a memory storage device;
2. The apparatus of the present invention acting as a processing device;
3. The apparatus of the present invention acting as an electronic purse;
4. The apparatus of the present invention acting as a secure compact disk; and
5. The apparatus of the present invention acting as a Java compact disk.

The present invention may be configured such that a user must communicate a PIN code contained within the digital data stored on the apparatus when installed in a traditional compact disk peripheral device.

This may be configured in one of two ways; through the use of PIN codes i.e. (read only PIN codes) updated to the media player on the user's personal computer; or downloading the PIN code for that disk the first time that disk is being played on that personal computer to your media player to gain access to the data stored on the apparatus.

The present invention is a digital asset management solution with feature-rich security and copy-prevention systems. The present invention provides CD/DVD manufacturers and the music recording industry, as well as software and gaming manufacturers, with an advanced range of compact disk security tools to better manage and secure digital data and what could be done with it or who has access to it.

The present invention enables compact disk manufacturers of all kinds as well as end users, to play a compact disk in a CD/DVD playing device, without being able to copy the binary data stored within the System-On-Chip flash memory module.

Furthermore, it is envisioned that a stand-alone media player for the present invention, which would double as a media player as well as a data upload port to the present invention, would allow the end user to record digital data and encrypt that data on the apparatus. Once data has been uploaded to the apparatus, only users with a valid PIN code will have access to the recorded data, whether that data is audio, video or software, the user will only be able to read, view, or listen to the data if and when they purchase a PIN code from the original product manufacturer of the data or software stored on the apparatus of the present invention.

To communicate with the apparatus of the present invention or to develop an application that is compatible with the apparatus, the user must have a reader (media player) that is updated with a user access level PIN code downloaded to the user's personal computer from any compact disk manufacturers and music industry companies' websites, as they become available.

The updated reader (media player) provides a path for an application to send and receive commands from the apparatus. There are many types of readers (media player) on the market, the most prevalent being Windows media player by Microsoft.

Each apparatus of the present invention provides a different protocol for speaking to a reader depending on the data or application resident on the apparatus.

The one protocol for communicating with an apparatus of the present invention is based on the Application Protocol Data Unit format defined in ISO Specification 9660, IEC 908, and ISO 10149.

The physical structure of the apparatus of the present invention conforms to the standards for compact disks specified by the International Standards Organization (“ISO”).

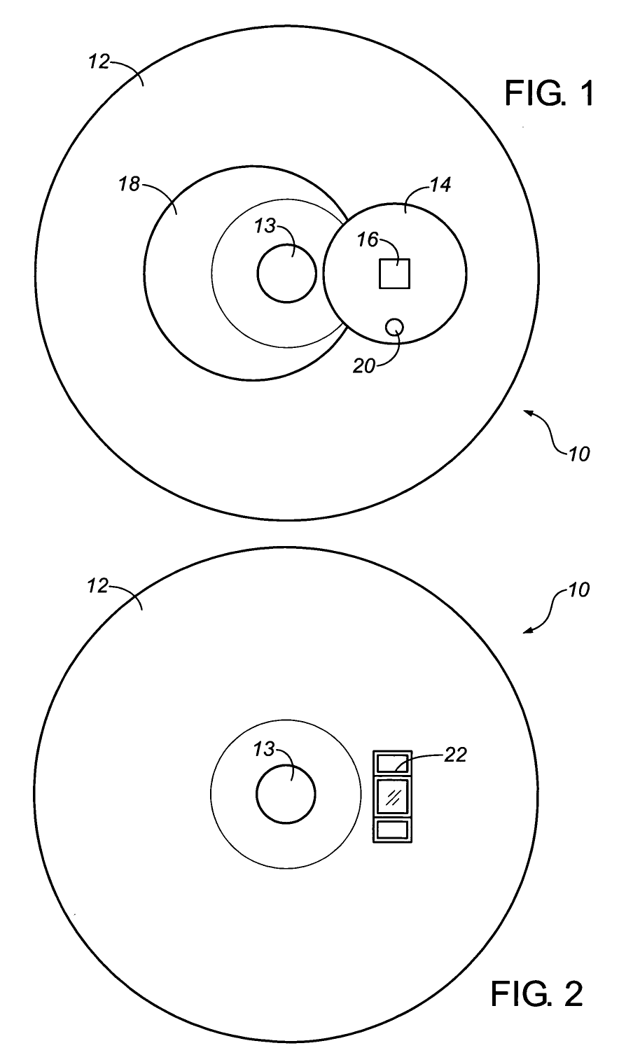

Referring to FIG. 1, the top view of a first embodiment of the apparatus of the present invention is shown. Disk 10 is comprised of substrate 12 which is of the same form factor of industry standard compact disks, namely, a 120 mm diameter disk that is 1.2 mm thick having a central hole 13 that is 15 mm in diameter. Printed circuit layer 14 is placed on one side of hole 13. Microprocessor 16 in mounted on circuit layer 14 and is powered by power cell 20. Power cell 20 is a battery of sufficient voltage and current capacity to power the embedded electronics on disk 10. The mass of microprocessor 16, circuit layer 14 and power cell 20 is counterbalanced by counterweight 18 mounted on the opposing side of hole 13.

The microprocessor circuit layer conforms to ISO standards, which provides five connection points for power and data. The circuit layer, with the microprocessor soldered to the layer, is hermetically fixed in the recess provided on the compact disk substrate, filled with conductive material, and sealed with contacts protruding.

The polycarbonate disk in which the microprocessor is embedded protects the microprocessor and other embedded components from mechanical stress and static electricity.

Referring to FIG. 2, the bottom view of the first embodiment of the present invention is shown. Optical interface device 22 is mounted on the bottom side of substrate 12 underneath circuit layer 14 and microprocessor 16 and is electrically connected to microprocessor 16 and power cell 20 through circuit layer 14 in a manner that should be well known to those skilled in the art.

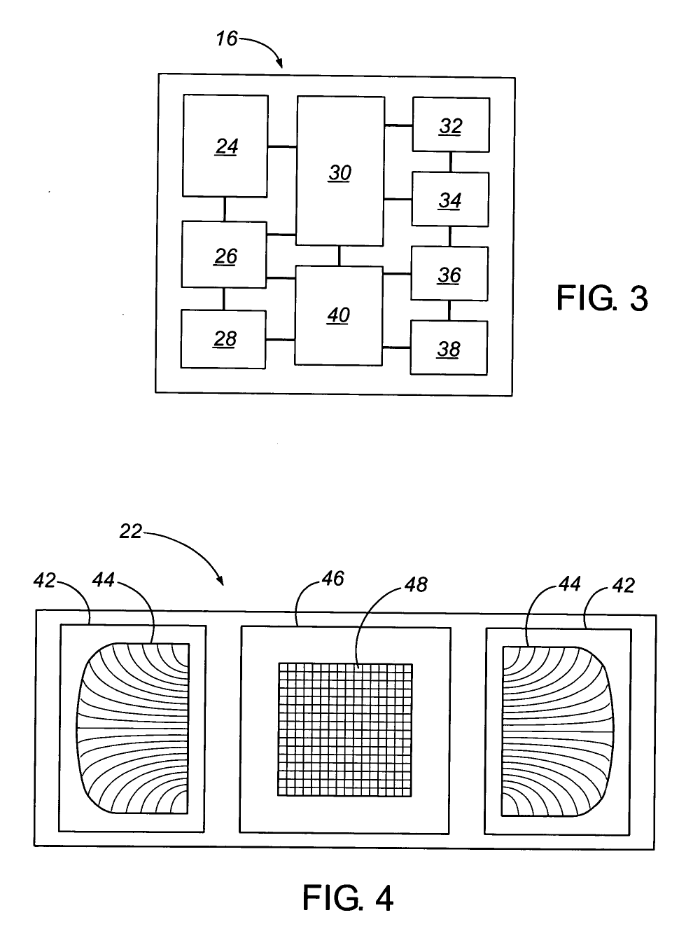

Referring to FIG. 3, a schematic block diagram of microprocessor 16 is shown. Microprocessor 16 can be of any form of the numerous types of microprocessors known to those skilled in the art. In its basic form, microprocessor 16 comprises the following functional components that can be implemented as hardware elements or emulated through the system-level operating system software or firmware embedded in the device. Microprocessor 16 comprises a main processor core 24, system memory 26 for storing code changes, logic circuitry 28 for user-defined functionality, data memory 30 for storing data received from a compact disk peripheral device, ram cache 32 for rapid access to operational data, peripheral interface 34 for communicating with peripheral devices, digital signal processing core 36 for high-bandwidth signal processing, bus interface 38 for transferring data internally and analog processor core 40 for converting analog signals to digital format. The current microprocessor and the peripheral devices are made from silicon, which is not flexible and particularly easy to break. Therefore, in order to avoid breakage when the apparatus is bent, the microprocessor and the peripheral devices are restricted to only a few millimeters in size.

Referring to FIG. 4, a schematic block diagram of optical interface device 22 is shown. Optical interface device 22 comprises of two imaging sensors 42 separated by MEMS mirror array 46. Each sensor 42 is a charge-coupled device having a grid of pixels that measure, preferably, 750 pixels wide by 480 pixels high. Sensors 42 operate to receive data from the laser of a compact disk peripheral device that is to be stored on disk 10. In addition to reading the data from the laser, sensors 42 also determine the relative position of the laser with respect to disk 10 and relay that information to microprocessor 16 that, in turn, determines whether the laser is sufficiently aligned with sensors 42 or whether a command signal is required to be transmitted to the compact disk peripheral device in order to realign the position of the laser with sensors 42. MEMS mirror array 46 is a grid of micro mirror elements 48, each of which are individually controllable. In a representative embodiment, array 46 comprises of 1200 mirror elements wide and 840 mirror elements high to provide 1,008,000 mirror elements in total. Array 46 is used to transmit data retrieved from disk 10 to a compact disk peripheral device. To accomplish this, mirror elements 48 are controlled by microprocessor 16 to appear either as “pits” or “lands” as one would normally find on a conventional CD. As disk 10 passes over the laser pickup mechanism of a compact disk peripheral device, mirror elements 48 either reflect or do not reflect the laser light back to the laser mechanism to represent the binary ones or zeros of the data being retrieved from disk 10.

The optical interface device utilized by the present invention allows data exchange between the microprocessor and the compact disk peripheral device is only limited to the compact disk playing device the apparatus of the present invention is inserted into. The communication protocol is a bi-directional optical transmission path that conforms to ISO standards. All the data exchanged from the apparatus to the compact disk peripheral device will have an embedded encrypted PIN code, thus, it is under the control of the microprocessor embedded in the apparatus.

The exchange of data or information between the apparatus and the compact disk peripheral device is sent in half duplex mode or full duplex mode, which means that the transmission of data is in one direction at a time or in both directions depending on whether the user is using a compact disk peripheral device equipped with the capability to record data onto a recordable compact disk.

As noted above, powering the present invention can be done by a power cell that is operatively attached to the apparatus of the present invention to provide electrical power to microprocessor 16, optical interface device 22, system memory 26 and data memory 30. In a second embodiment of the present invention, the present invention can be powered by electrostatic charges generated as disk 10 is spun in a compact disk peripheral device.

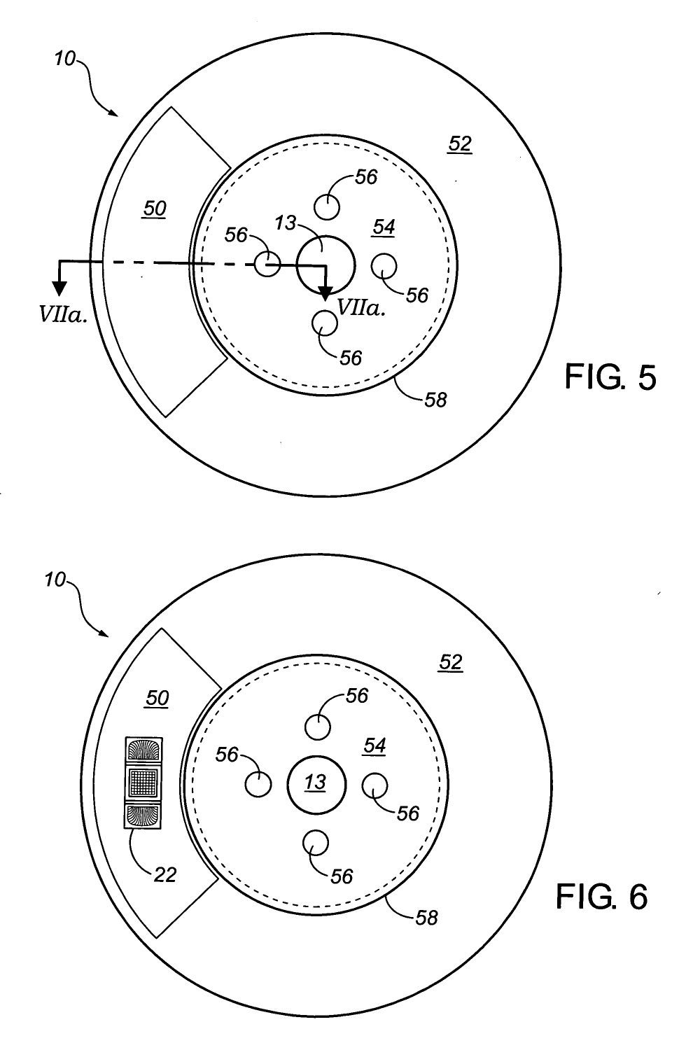

Referring to FIG. 5, a top view of the second embodiment of the present invention is shown. In this embodiment, the power required by the embedded electronic devices is provided by disk 10 generating static electricity as it spins in a compact disk peripheral device. Disk 10 comprises of inner disk 54 and annular outer disk 52 having spin gap 58 separating them thereby allowing outer disk 52 to rotate about the circumferential edge of inner disk 54. Inner disk 54 is referred to as the “Solenoid” whereas outer disk 52 is referred to as the “Plane”. Monolithic chip 50 comprises microprocessor 16 and optical interface device 22. FIG. 6 is a bottom view of this second embodiment showing optical interface device 22 mounted upon the bottom side of monolithic chip 50 as it extends through substrate 12.

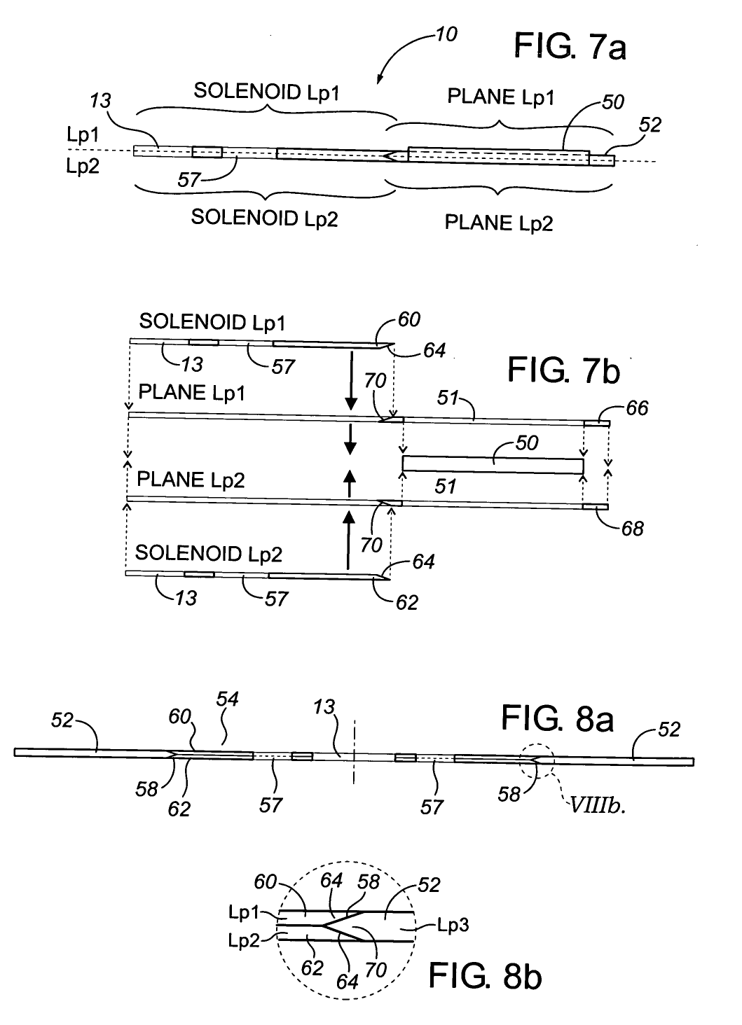

Referring to FIGS. 7a and 7b, a partial cross-sectional side view of the second embodiment is shown. Monolithic chip 50 is sandwiched between layers 66 and 68 that form outer disk 52 that are, in turn, sandwiched by layers 60 and 62 that form inner disk 52. Anchors 56 pass through cavities 57 to secure layers 60 and 62 together. Outer disk layers 66 and 68 have wings 70 that form a V-shaped profile whereas inner disk layers 60 and 62 have wings 64 that form a V-shaped groove that corresponds to wings 70. The diameter of inner disk layers 60 and 62 are selected such that there is spin gap 58 between inner disk 54 and outer disk 52. Spin gap 58 is in the order of 0.1 mm±0.01 mm.

Referring to FIG. 8a, a full cross-sectional side view of the second embodiment is shown. Referring to FIG. 8b, a close-up view of the transition from inner disk 54 to outer disk 52 is shown. Wings 70 of outer disk 52 form an angle in the order of 30°. Wings 64 of inner disk layers 60 and 62 form a groove that is also in the order of 30°.

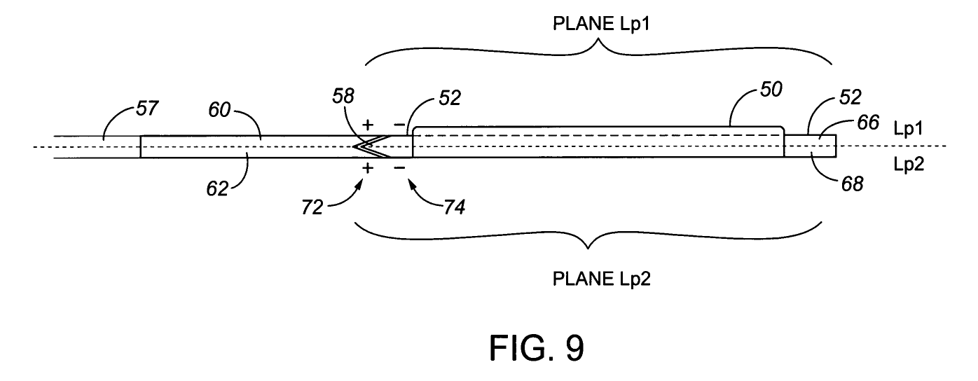

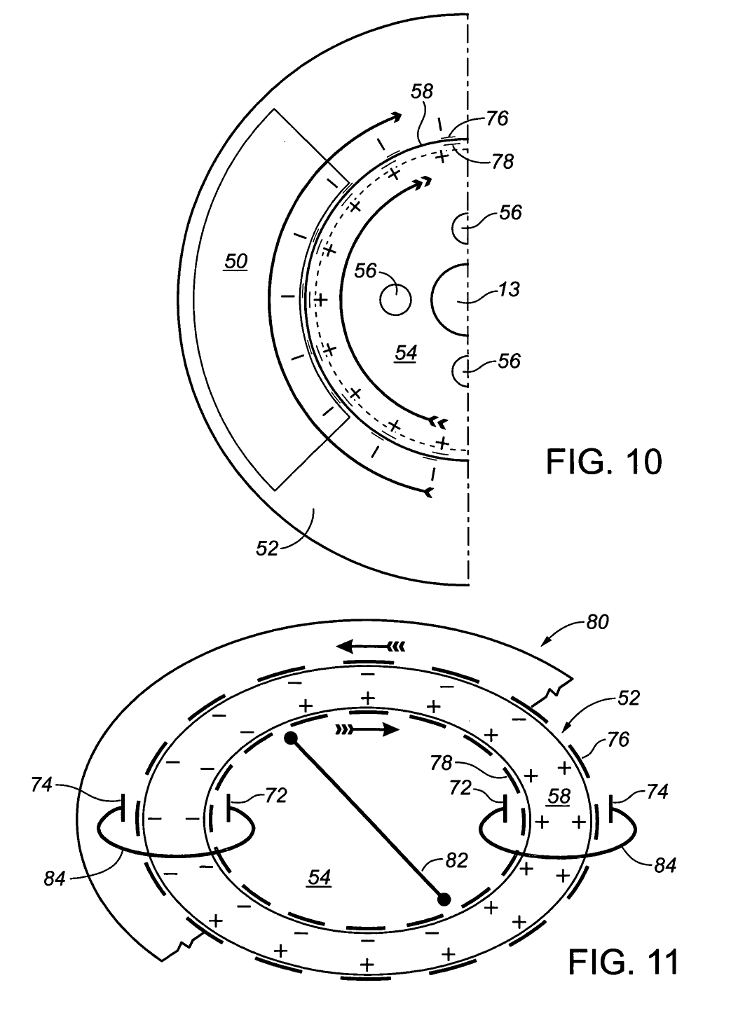

Referring to FIG. 9, spin gap 58 is more clearly shown. In addition, inner disk charge collectors 72 are shown on inner disk 54 and outer disk charge collectors 74 are shown on outer disk 52. Referring to FIG. 10, inner disk 54 is shown turning in a clockwise direction as it would when disk 10 is inserted into a compact disk peripheral device. As outer disk 52 can spin freely about inner disk 54, outer disk 52 will still spin at approximately half the rotational speed of inner disk 54 due to the frictional forces that exist between the disks within spin gap 58. As the disks are made of polycarbonate, an insulating material, electrons are stripped off of inner disk 54 as it spins past outer disk 52 thereby resulting in a build-up of positive charge on inner disk 54 and negative charge on outer disk 52. A number of brushes 76 are placed equidistant apart on outer disk 52 near spin gap 58 and a corresponding number of brushes 78 are placed equidistant apart on inner disk 54 near spin gap 58. Referring to FIG. 11, the positive and negative charges are collected by charge collectors 84 that are connected to inner disk charge collectors 72 and outer disk charge collectors 74. The resulting positive and negative charges collected results in a voltage potential that can be stored and filtered by on-disk capacitive filtering (not shown) and regulated to the required voltage for powering the embedded electronics on disk 10 as should be obvious to those skilled in the art.

The method of the present invention comprises of two basic functions: storing data on the apparatus of the present invention and retrieving data stored on the apparatus of the present invention. These methods are carried out by

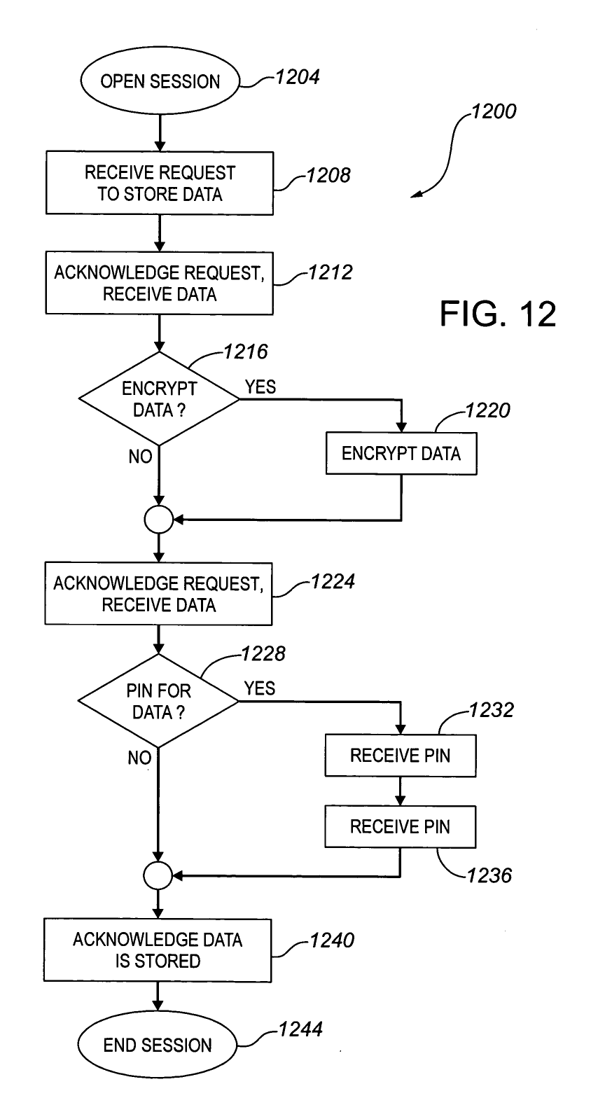

Referring to FIG. 12, the method of storing data is shown. Data storing process 1200 comprises of step 1204 to open a data storing session where a request to store data is received at step 1208. At step 1212, the request is acknowledged. At step 1216, an inquiry is made whether the data to be stored is to be encrypted. If yes, the data is encrypted at step 1220. If not, process 1200 proceeds to step 1224 where the data is stored in data memory 30 of microprocessor 16. At step 1228, an inquiry is made whether there is a password or PIN to be associated with the stored data. If yes, the PIN is received at step 1232 and stored at step 1236. If not, process 1200 proceeds to step 1240 where an acknowledgment is made that the data has been stored and the session is closed at step 1244.

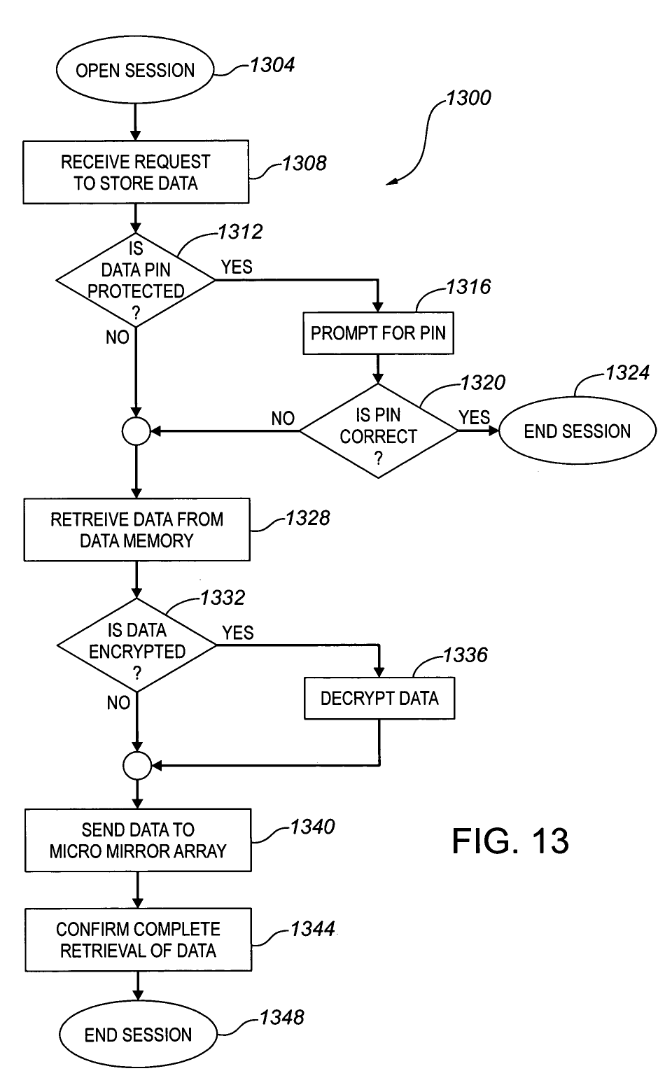

Referring to FIG. 13, the method of retrieving data is shown. Data retrieval process 1300 comprises of step 1304 to open a data retrieval session where a request to retrieve data is received at step 1308. At step 1312, an inquiry is made whether the data is password or PIN protected. If yes, a prompt for the password or PIN is made at step 1316. At step 1320, another inquiry is made whether the received password or PIN is correct. If not, the session ends at step 1324. If yes, process 1300 continues to retrieve data from data memory 30 at step 1328. If the data is not protected, then process 1300 also process to step 1328. At step 1332, an inquiry is made whether the data is encrypted. If yes, the data is decrypted at step 1336. If not, process 1300 process to step 1340 where the retrieved data is sent to micro mirror array 46. At step 1344, the complete retrieval of data is confirmed followed by the session ending at step 1348.

After an apparatus of the present invention and its PIN is activated, the protection of the data stored on the apparatus will be controlled primarily by the updated media player.

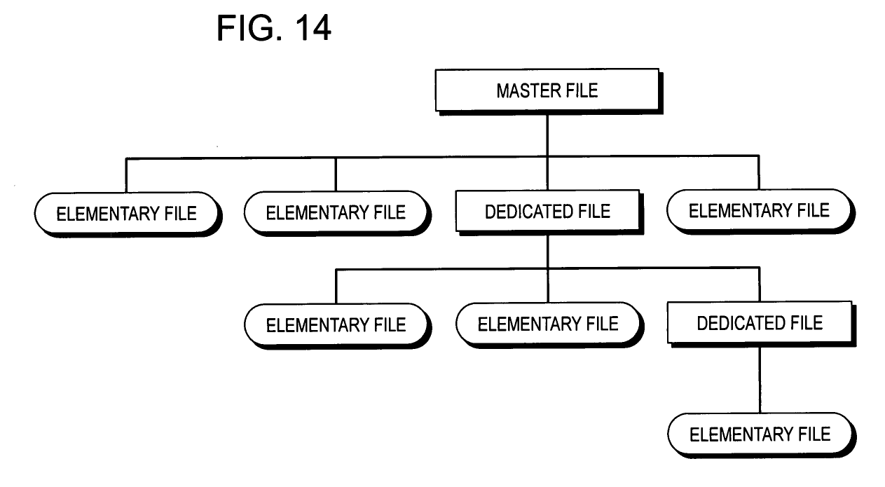

Generally, in terms of data storage, the apparatus of the present invention can be viewed as a disk drive or processor-to-processor optical communication where files are organized in a hierarchical form through directories. Similar to Microsoft's Disk Operating System (“MS-DOS”), there is one master file (MF) that is similar to the root directory. Under the root, we can have different files that are called elementary files (EFs). We can also have various subdirectories called dedicated files (DFs). Under each subdirectory will be elementary files again. This is illustrated in FIG. 14. The main difference of the file structure of the present invention and a MS-DOS file structure is that dedicated files can also contain data.

In the present invention, the root or master file (MF), besides the header part which consists of itself, the body part contains the headers of all of the dedicated files and elementary files which contain the MF in their parental hierarchy. The dedicated file (DF) is a functional grouping of files consisting of itself and all the files which are immediate offspring of the DF. The elementary file (EF) simply consists of its header and the body, which stores and retrieves the data from the Flash memory module and then sends an electrical impulse to the corresponding individually addressable micro mirror, which them moves to its corresponding pitch, thus representing a predetermined binary bit pattern.

The ways that the data is managed within a file differ, and are dependent on different operating systems. Some of them may manage the data simply by offset and length, while the others may organize data in fixed or variable lengths of records such as Global System for Mobile Communication (GSM). In any case, the file must be selected before performing any operations. This is equivalent to opening and unlocking the apparatus of the present invention.

The logical access and selection mechanisms are activated after the power is supplied to the apparatus. While the master file is selected automatically, the selection operation allows movement around the tree. It can descend by selecting an EF or a DF, or it can ascend by selecting a MF or DF. Horizontal movement is accomplished by selecting an EF from another EF.

After the completion of this, the header of the file can be retrieved, which stores the information about the file such as identification number, description, types, size, and so on. Particularly, it stores the attribute of the file that states the access conditions and current status. Access of the data in the file depends on whether those conditions can be fulfilled or not. In short, the file structure of the operating system of the present invention is similar to other common operating systems such as MS-DOS or UNIX. However, in order to provide greater security control, the attributes of each file is enhanced by adding accessing conditions and file status fields in the file header. Moreover, file lock is also provided to prevent the file being accessed. These security mechanisms and algorithms provide a logical protection of the data stored on the apparatus of the present invention.

The access control system of the present invention covers file access mainly from the apparatus. Each file that is downloaded from the apparatus is attached with a header that indicates the access conditions or requirements of the file and the current status as well. The fundamental principle of the access control is based on the correct presentation of PIN numbers and their management.

Primarily, the access conditions of the apparatus of the present invention can be defined into the following five levels. Some of the operating systems may offer more than these depending on the application they provide.
Always (ALW): Access of the file can be performed without any restriction.
SCD—owner/holder verification 1 (SCDV1): Access can only be possible when valid SCDV1 value is presented.
SCD—owner/holder verification 2 (SCDV2): Access can only be possible when valid SCDV2 value is presented.
Administrative (AD): Allocation of these levels is done by an adminstrator.
Never (N): Access of the file is forbidden.

Those condition levels are not hierarchical. For instance, correct presentation of SCDV2 does not mean that access of file is allowed, which requires presentation of SCDV1. During the operation of the present invention, corresponding requirements have to be fulfilled before the selection of the file off the apparatus. For example, correct SCDV1 value has to be presented if it is the access condition of a file stored on the apparatus.

The PINs are normally stored in separate elementary files located in the embedded chip on the apparatus, EF_{SCDV1} and EF_{SCDV2} for example. Use of the access conditions on those files can prevent the PINs from being changed. Issuing the change PIN instruction together with the new and old PIN can change the PIN. However, for most of the operating systems of the present invention, the corresponding PIN will be invalidated or blocked when a predetermined number of invalid PINs are presented consecutively. The number of times will vary with different systems trying to access the present invention.

At this moment, all the files that require that PIN will be blocked and made inaccessible. Unblocking has to be carried out with the knowledge of the correct PIN and a specific unblocking PIN stored in on the apparatus. Still, if an invalid unblocking PIN is presented consecutively and up to a predetermined number of times, the unblocking PIN will be blocked as well. Then both of the PIN and the unblocking PIN will be invalidated and are no longer able to be restored. This is called an irreversible blockage. The present invention may be configured to invalidate the whole apparatus in order to prevent further attacks.

To achieve the protection and blockage of the PINs mentioned above, two counters have to be implemented for each of the holder verification numbers (SCDVs) of the present invention. The counters are composed in such a way that any possible errors in writing or erasing will be avoided, which could adversely affect the access control on the apparatus. The three states of the management of the PIN are described below.

1. SmartCD® PIN has been Presented:

The files or functions that have PIN presentation as a pre-requisite or condition can be carried out. Every time the PIN is presented correctly, the PIN counter will be reset to the maximum number of tries, three for example.

2. SmartCD® PIN has not been Presented or was Presented Incorrectly:

The PIN counter will be decremented by one after each incorrect PIN was presented. All the operations or instructions that require PIN presentation will be invalidated. If the PIN counter reaches zero, the PIN will be blocked.

3. SmartCD® PIN is Blocked:

In this state, all the operations require PIN presentation and even the PIN presentation instruction itself is blocked. Unblocking PIN instruction has to be carried out. If correct unblocking PIN is presented, the PIN counter will be reset to the maximum number of tries and returned back to its first state. However, if invalid unblocking PIN is presented, the unblock PIN counter will be decremented by one and when this counter reaches zero, the PIN can never be unblocked again by the user. The CD will have to be returned to the applicant of the present invention to gain access to the data stored thereupon.

Within each apparatus of the present invention, there is an operating system that may contain some of the following:
1. Manufacturer Identification number (ID).
2. Type of component, (software, Audio, video etc.).
3. Serial number, (like a RFID tag each CD has it's own ID that belongs to that product forever).
4. Profile information, and so on.

In addition to the above, the SCD® systems area may contain different security keys, such as:

Manufacturer Key

Fabrication key (KF)

Personalization key (KP)

The production of the present invention is divided into different phases. There are five phases that have been determined for the life cycle of the present invention.

1. Fabrication Phase

This phase is carried out by the manufacturer(s) of the microprocessor used in the present invention. The microprocessor is created and tested in this phase. A fabrication key (KF) is added to protect the microprocessor from fraudulent modification until it is assembled into the CD substrate. The KF of each microprocessor is unique and is derived from a master manufacturer key. Other fabrication data will be written to the circuit chip at the end of this phase. Then the microprocessor is ready to be delivered to the CD manufacturer with the protection of the key KF.

2. Pre-Personalization Phase

This phase is carried out by the manufacturers of the apparatus of the present invention. In this phase, the microprocessor will be mounted on the plastic CD substrate which may have the logo of the provider printed on it. The connection between the microprocessor and the printed circuit will be made, and the whole unit can be tested. For added security, some versions of present invention will have the fabrication key replaced by a personalization key (KP). After that, a personalization lock VPER will be written to prevent further modification of the KP. In addition, physical memory access instructions will be disabled on some versions of SmartCD®. Access of the SCD® can be done only by using logical memory addressing. This preserves the system and fabrication areas being accessed or modified.

3. Personalization Phase

This phase is conducted by the manufacturers of the data or software to be stored on the apparatus of the present invention. It completes the creation of logical data structures. Data files content and application data are written to the apparatus. Information of the data or software manufacturer, the PIN, and the unblocking PIN will be stored on the apparatus as well. At the end, a utilization lock VUTIL will be written to indicate the apparatus is in the utilization phase.

4. Utilization Phase

This is the phase for the normal use of the apparatus of the present invention. The application system, logical file access controls, and others are activated. Access of information on the apparatus will be limited by the security policies set by the CD manufacturer.

5. End-of-Life Phase (Invalidation Phase)

There are two ways to move the present invention into this phase. The first way to enter the end-of-life phase is initiated by the product or data manufacturers who write an invalidation lock onto an individual apparatus. All operations including writing and updating features will be disabled by the operating system. Only the read instructions may remain active for analysis purposes until the user acquires an authorization PIN to access the functions stored on the apparatus. The other way the end-of-life phase is entered is when the control system irreversibly blocks access because both the PIN and unblocking PIN are blocked. As discussed above, all the operations will be blocked including reads.

Each of the foregoing phases are summarized in Table 1 shown below.

TABLE 1
Phases and access rights of the life cycle of the Present Invention

| | | | | | |
|---|---|---|---|---|---|
| | | Pre- | | | End-of- |
| Areas/Phases | Fabrication | personalization | Personalization | Utilization | Life |

| Access mode | Physical addressing | | Logical addressing |
|---|---|---|---|
| System | Not accessible | | |
| Fabrication | Write KF | Write KP | Not accessible |
| Fabrication | Read, write, | Read | Read |
| (data) | erase | | |

| | | |
|---|---|---|
| Directory | Read, write, erase | According to logical file access |
| | | conditions |
| Data | Read, write, erase | According to logical file access |
| | | conditions |
| Optional code | Read, write, erase | Not accessible |

Although a few preferred embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized at the scope of the invention as defined and limited only by the claims that follow.

We claim:

1. A compact disk for securely receiving and storing data for later retrieval, comprising:
a) a compact disk substrate adapted for insertion into a compact disk peripheral device;
b) a microprocessor operatively connected to said substrate, said microprocessor adapted to control the exchange of data between said compact disk and said compact disk peripheral device;
c) an optical interface device operatively connected to said substrate and to said microprocessor, said optical interface device adapted to receive data from and to transmit data to said compact disk peripheral device;
d) a system memory operatively connected to said microprocessor, said system memory adapted to be programmed with a system program code segment having a first set of instructions adapted to cause said microprocessor to store data received by said optical interface device in said data memory, and having a second set of instructions adapted to cause said microprocessor to retrieve data stored in said data memory for transmittal by said optical interface device, said microprocessor adapted to follow said first set or said second set of instructions when said compact disk in inserted into said compact disk peripheral device;
e) a data memory operatively connected to said microprocessor, said data memory adapted to receive data to be stored for later retrieval; and
f) power means for providing electrical power to said microprocessor, said optical interface device, said system memory and said data memory, said power means operatively attached to said compact disk substrate.

2. The compact disk as set forth in claim 1 wherein said optical interface device comprises an imaging sensor for receiving data from said compact disk peripheral device and a micro electro-mechanical mirror array for transmitting data to said compact disk peripheral device.

3. The compact disk as set forth in claim 1 wherein said system program code segment further comprises a third set of instructions capable of encrypting data stored in said data memory and decrypting encrypted data retrieved from said data memory.

4. The compact disk as set forth in claim 1 wherein said system program code segment further comprises a fourth set of instructions capable of securing data stored in said data memory with a predetermined password and allowing access to password-secured data stored in said data memory only when said microprocessor receives said predetermined password.

5. The compact disk as set forth in claim 1 wherein said power means comprises a power cell.

6. The compact disk as set forth in claim 1 wherein said power means is comprised of said compact disk substrate being adapted to generate static electricity when it is inserted in said compact disk peripheral device.

7. A method for storing data on a compact disk for recording and storing data for later retrieval, the method comprising the steps of:
a) providing a compact disk for securely recording and storing data for later retrieval, comprising:
i) a compact disk substrate adapted for insertion into a compact disk peripheral device,
ii) a microprocessor operatively connected to said substrate, said microprocessor adapted to control the exchange of data between said compact disk and said compact disk peripheral device,
iii) an optical interface device operatively connected to said substrate and to said microprocessor, said optical interface device adapted to receive data from and to transmit data to said compact disk peripheral device,
iv) a system memory operatively connected to said microprocessor, said system memory adapted to be programmed with a system program code segment having a first set of instructions adapted to cause said microprocessor to store data received by said optical interface device in said data memory, and having a second set of instructions adapted to cause said microprocessor to retrieve data stored in said data memory for transmittal by said optical interface device, said microprocessor adapted to follow said first set or said second set of instructions when said compact disk in inserted into said compact disk peripheral device,
v) a data memory operatively connected to said microprocessor, said data memory adapted to receive data to be stored for later retrieval, and
vi) power means for providing electrical power to said microprocessor, said optical interface device, said system memory and said data memory, said power means operatively attached to said compact disk substrate;
b) receiving data at said optical interface device; and
c) storing said received data in said data memory.

8. The method as set forth in claim 7 wherein said received data is encrypted prior to being stored in said data memory.

9. The method as set forth in claim 7 wherein said received data is protected with a predetermined password when said received data is stored in said data memory.

10. A method for retrieving data from a compact disk for recording and storing data for later retrieval, the method comprising the steps of:
a) providing a compact disk having data securely recorded and stored for later retrieval, comprising:
i) a compact disk substrate adapted for insertion into a compact disk peripheral device,
ii) a microprocessor operatively connected to said substrate, said microprocessor adapted to control the exchange of data between said compact disk and said compact disk peripheral device,
iii) an optical interface device operatively connected to said substrate and to said microprocessor, said optical interface device adapted to receive data from and to transmit data to said compact disk peripheral device,
iv) a system memory operatively connected to said microprocessor, said system memory adapted to be programmed with a system program code segment having a first set of instructions adapted to cause said microprocessor to store data received by said optical interface device in said data memory, and having a second set of instructions adapted to cause said microprocessor to retrieve data stored in said data memory for transmittal by said optical interface device, said microprocessor adapted to follow said first set or said second set of instructions when said compact disk in inserted into said compact disk peripheral device,
v) a data memory operatively connected to said microprocessor, said data memory adapted to receive data to be stored for later retrieval, and
vi) power means for providing electrical power to said microprocessor, said optical interface device, said system memory and said data memory, said power means operatively attached to said compact disk substrate;
b) retrieving said stored data from said data memory; and
c) transmitting said retrieved data from said optical interface device.

11. The method as set forth in claim 10 wherein said stored data is encrypted.

12. The method as set forth in claim 11 wherein said stored data is decrypted prior to being transmitted from said optical interface device.

13. The method as set forth in claim 10 wherein said stored data is password protected with a predetermined password.

14. The method as set forth in claim 13 wherein said stored data is transmitted from said optical interface device only after said microprocessor receives said predetermined password.
